(19) United States
(12) Patent Application Publication
(10) Pub. No.: US 2026/0266968 A1
(43) Pub. Date: Sep. 10, 2026

(54) SYSTEMS AND METHODS FOR SINGLE-PHOTON LIDAR VELOCIMETRY AND RANGE ESTIMATION

(71) Applicant: Mitsubishi Electric Research Laboratories, Inc., Cambridge, MA (US)

(72) Inventors: Joshua Rapp, Somerville, MA (US); Yanting Ma, Allston, MA (US); Hassan Mansour, Newton, MA (US); Ruangrawee Kitichotkul, Allston, MA (US)

(21) Appl. No.: 19/072,836

(22) Filed: Mar. 6, 2025

(51) Int. Cl. G01S 7/487; G01S 7/486; G01S 17/42

(52) U.S. Cl. CPC G01S 7/487; G01S 7/4868; G01S 17/42

(57) ABSTRACT

A system for joint estimation of range and instantaneous velocity of a movable target in a scene comprises circuitry configured to control an illumination source to emit an illumination pulse train at a pulse repetition frequency for illuminating the scene. The circuitry is further configured to collect an observed pulse train corresponding to illumination reflected from the scene. The circuitry is further configured to record photon detection times associated with the observed pulse train and perform frequency analysis on the recorded photon detection times to extract frequency and phase of observed pulse train. The circuitry is further configured to estimate the range and velocity of the target object based on the extracted frequency and phase of the observed pulse train.

### TECHNICAL FIELD

The present disclosure relates generally to object detection in a scene, and more particularly, to Single-Photon LiDAR based devices and methods for measuring range and velocity of moving objects.

### BACKGROUND

Object detection and tracking is an essential component of many real-world applications. Several application areas such as autonomous vehicles, industrial robotics, navigation, aerospace, meteorological element measurement, atmospheric environment monitoring etc. require precise detection and/or tracking of objects for performing critical functions. There are several approaches of varying complexities and accuracy available for tracking objects in a scene. Image processing-based approaches are suitable for object tracking in a short range but are limited by illumination requirements. On the other hand, remote sensing approaches are suitable for tracking distant objects without relying on the received signal's intensity or other parameters. For example, radar-based approaches simply rely on reception of reflections without getting into the complexities of processing those reflected signals. In this regard, time-of-flight of the signals is considered sufficient to measure the distance to an object.

Reliable object detection is usually performed using remote sensing techniques such as Light Detection and Ranging (LiDAR or simply Lidar) that uses light in the form of a pulsed laser to measure ranges (distances) to objects in a scene. However, measurement of velocity of moving objects requires complex further processing with the conventional Lidar systems. While Frequency-modulated continuous-wave (FMCW) lidar can measure velocity from the Doppler shift in the received optical frequency, Amplitude-modulated continuous-wave (AMCW) lidar can be configured to measure velocity from the Doppler shift in the received modulation frequency. However, both FMCW and AMCW are applicable for limited range. An advanced type of Lidar is a Single-Photon Lidar (SPL), also known as Geiger-mode Lidar, that leverages the properties of single-photon detectors for depth sensing and three-dimensional (3D) mapping. It differs from traditional lidar systems by using sensors capable of detecting individual photons, providing high sensitivity and precision.

The existing SPL systems are not configured for direct measurement of velocity of moving objects. Available methods rely on estimating velocity from a sequence of range estimates. However, such approaches do not consider the multi-dimensional motion of the moving objects and often account only for the longitudinal motion of the objects. Furthermore, the velocity measurement provided by such methods is inaccurate and not in real-time because the object (target) is moving during the estimation time period.

Consequently, the existing Lidar systems are not suitable for velocity and range estimation of moving targets beyond the unambiguous range. Therefore, there is a need for effective and accurate measurement of range and velocity of movable targets without increasing the complexity of underlying hardware and processing.

### SUMMARY

It is an object of some embodiments to provide improved techniques for estimating range and velocity of movable objects in a scene. Some embodiments are directed towards systems and methods for joint estimation of range and velocity of a movable object using a single photon lidar (SPL). Unlike conventional approaches which attempt to estimate range from a single pulse, some embodiments utilize a sequence of pulses to increase the probability of detecting photons reflected from the object.

It is a realization of some embodiments that object velocity estimation using Lidar typically requires regression over several distance measurements. Some approaches for extraction of velocity estimates from the sequence of range estimates utilize linear regression, Kalman filtering, or the Hough transform. One approach in this regard is based on velocity estimation from a sequence of range estimates using SPL. However, some embodiments realize that each such range estimate assumes the observer and target are static which is not true for objects in motion. In fact, such an assumption degrades the quality of the range estimate because there is often an obvious mismatch when trying to track moving objects.

Furthermore, some embodiments also recognize through experiments that during the process of making a sequence of range estimates, a target may have motion in both longitudinal and transverse directions. Looking at the change in distance only accounts for longitudinal motion. Therefore, some embodiments are also based on the understanding that tracking is needed in the transverse direction to ensure that the range estimates correspond to the same object.

Some embodiments also recognize that a target moving at a constant velocity introduces a Doppler shift into the sequence of photon detection times. As such, the periodic illumination of SPL can be considered to be a form of amplitude-modulated continuous-wave (AMCW), where the amplitude modulation is a pulse train rather than a sinusoid. Thus, the velocity of an illuminated target likewise causes a Doppler shift, which can be observed as a change in the pulse repetition frequency. Driven by these insights, various embodiments introduce a Doppler SPL which enables joint estimation of instantaneous velocity and range of a movable object. Rather than using a single pulse, various example embodiments utilize a sequence of illumination pulses for measuring the range to an object in motion. Such a Doppler SPL enables velocimetry by quantifying the difference between the transmitting frequency and the Doppler-shifted receiving frequency. The Doppler SPL holds distinction over conventional SPL systems at least in the fact that because the modulation considered is a pulse train rather than a sinusoid, the Doppler shift occurs not only for the fundamental repetition frequency but also the higher harmonics.

Accordingly, some embodiments provide approaches for estimating the Doppler-shifted pulse repetition frequency from the sequence of photon detection times in an SPL system. Various embodiments also provide estimators for range and velocity based on Fourier analysis of the detection time sequence. The range and velocity thus estimated is more accurate in comparison to conventional solutions because the assumption that the target is static during the estimation no longer applies.

Some embodiments are based on another realization that the estimation of velocity and range using Fourier analysis of the photon detection times may suffer from performance degradation due to decrease in signal to background ratio. As such, the Fourier approach requires further upgrade to account for uninformative detections from ambient light and dark counts. Some embodiments utilize the outputs of the Fourier estimators as initializations for a maximum likelihood estimation procedure that jointly optimizes over the velocity and starting distance, as well as the flux levels of signal and background photons. Such an estimator is robust to strong background light and is statistically efficient, achieving the Cramer-Rao Bound.

The maximum likelihood (ML) estimation approach takes the initial estimate of the velocity of the target from the Fourier estimator and computes hypothetical relative detection times assuming the target is not moving so as to obtain a preliminary estimate of the starting distance, as well as the flux levels of signal and background photons. Given the signal flux estimate and the background flux estimate, the ML distance estimator is applied for the initial time-of-flight. Using the initializations of the signal flux, background flux, velocity and the starting distance, the Limited-memory Broyden-Fletcher-Goldfarb-Shanno—bound constraints (L-BFGS-B) algorithm is applied to obtain the maximum likelihood estimate of the four parameters—the signal flux, background flux, instantaneous velocity and the distance of the target object is determined by solving an optimization problem.

In order to achieve the aforementioned objectives and advantages, various embodiments estimate the velocity based on a comparison of the Doppler-shifted pulse repetition frequency to the known illumination frequency. Furthermore, some embodiments also recognize that the phase at the Doppler-shifted frequency corresponds to the distance to the target. Range and velocity are thus estimated via Fourier analysis, and improved robustness is achieved via joint maximum likelihood estimation. Importantly, this means that the solution provided by various example embodiments avoid the problems encountered with other methods. For example, since the proposed solution makes an instantaneous velocity estimate, transverse tracking is not needed. Also, the proposed solution accounts for motion during the acquisition time, so there is no degradation in the estimated range and velocity due to the motion.

Accordingly, various example embodiments provide systems, methods, and computer program products for joint estimation of range and instantaneous velocity of a movable target in a scene.

In this regard, in one embodiment a system for joint estimation of range and instantaneous velocity of a movable target in a scene is provided. The system comprises circuitry configured to control an illumination source to emit an illumination pulse train at a pulse repetition frequency for illuminating the scene and collect an observed pulse train corresponding to illumination reflected from the scene. The circuitry is further configured to record photon detection times associated with the observed pulse train and perform frequency analysis on the recorded photon detection times to extract frequency and phase of observed pulse train. The circuitry is further configured to estimate the range and velocity of the target object based on the extracted frequency and phase of the observed pulse train.

In another embodiment a method for joint estimation of range and instantaneous velocity of a movable target in a scene is provided. The method comprises controlling an illumination source to emit an illumination pulse train at a pulse repetition frequency for illuminating the scene and collecting an observed pulse train corresponding to illumination reflected from the scene. The method further comprises recording photon detection times associated with the observed pulse train and performing frequency analysis on the recorded photon detection times to extract frequency and phase of observed pulse train. The method further comprises estimating the range and velocity of the target object based on the extracted frequency and phase of the observed pulse train.

Some example embodiments also provide a non-transitory computer readable medium having stored thereon instructions executable by a computer for performing a method for joint estimation of range and instantaneous velocity of a movable target in a scene is provided. The method comprises controlling an illumination source to emit an illumination pulse train at a pulse repetition frequency for illuminating the scene and collecting an observed pulse train corresponding to illumination reflected from the scene. The method further comprises recording photon detection times associated with the observed pulse train and performing frequency analysis on the recorded photon detection times to extract frequency and phase of observed pulse train. The method further comprises estimating the range and velocity of the target object based on the extracted frequency and phase of the observed pulse train.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a schematic of a system for joint estimation of range and velocity of a target object, according to some example embodiments;

FIG. 1B illustrates a method executed by the system of FIG. 1A for joint estimation of range and velocity of a target object, according to some example embodiments;

FIG. 2A shows a framework for measurement of range and instantaneous velocity of a moving target using a single photon lidar system, according to some example embodiments;

FIG. 2B shows a schematic of a pulsed single photon lidar system for range estimation and velocimetry, according to some example embodiments;

FIG. 3A illustrates a timing diagram showing an illumination pulse train produced by a pulsed single photon lidar system, according to some example embodiments;

FIG. 3B illustrates a timing diagram showing an observed pulse train detected by a pulsed single photon lidar system, according to some example embodiments;

FIG. 4A illustrates magnitudes of exemplary probed spectra and intensity spectra at first two harmonics of the transmission frequency of the illumination pulse train of FIG. 3A, according to some embodiments;

FIG. 4B illustrates magnitudes of exemplary probed spectra and intensity spectra at 30^{th} harmonic of the transmission frequency of the illumination pulse train of FIG. 3A, according to some embodiments;

FIG. 5 shows a detailed schematic of a single-photon lidar system for estimating range and velocity of a moving target, according to some example embodiments;

FIG. 6 illustrates a block diagram of a system for implementing a system for joint estimation of range and velocity of an object, according to some example embodiments; and

FIG. 7 illustrates a scenario depicting an example use case of a system for joint estimation of range and velocity of objects in a scene, according to some example embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, similar reference numbers and designations in the various drawings indicate similar elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

There has been a widescale adoption of object detection and tracking techniques in several application areas owing to the need to understand the environment around a subject for taking informed decisions. For example, in remote sensing applications, it is often desired that the physical characteristics of an area be described in as much clarity as possible. In other applications such as autonomous and semi-autonomous vehicles, taking time bound decisions is critical for the operation of such vehicles. For all such applications it is essential that range estimation of objects in the scene of interest be performed accurately. Additionally, there are many applications, in which range estimation and object tracking are necessary. Velocity information is increasingly desired, as it can help with detecting and tracking moving objects, e.g., pedestrians and vehicles. Measuring the velocity of moving objects in addition to determining distance can add important information in many of these applications. In automotive settings, for instance, velocity information can improve detection of moving pedestrians and vehicles, correct for motion distortion in point cloud registration, or assist in vehicle odometry.

LiDAR, or Light Detection and Ranging (also referred to as Lidar) is a common technology for ranging because it can achieve very good distance accuracy. Lidar is an increasingly popular sensing modality for ranging applications varying from autonomous driving to industrial robotics and lunar navigation. There are several types of lidar, and only some of them can be used to inherently measure velocity. For example, frequency-modulated continuous-wave (FMCW) lidar can measure velocity from the Doppler shift in the received optical frequency. Amplitude-modulated continuous-wave (AMCW) lidar can be configured to measure velocity from the Doppler shift in the received modulation frequency. However, both FMCW and AMCW have limited range.

An advanced type of Lidar is a Single-Photon Lidar (SPL), also known as Geiger-mode Lidar, that leverages the properties of single-photon detectors for depth sensing and three-dimensional (3D) mapping. It differs from traditional lidar systems by using sensors capable of detecting individual photons, providing high sensitivity and precision. Various Lidar systems rely on principles of pulse emissions. SPL operates on the same fundamental lidar principles but employs single-photon detectors, typically Single-Photon Avalanche Diodes (SPADs). The lidar system emits laser pulses toward the target, and the SPAD detectors measure the time it takes for individual photons to travel to the target and back. While Single-photon lidar (SPL) has long-range ability, the existing systems are not configured to measure velocity directly using SPL.

It is a realization of some embodiments that velocity can be estimated from a sequence of range estimates using SPL. Each individual estimate assumes the observer and target are static. There are a number of ways to extract velocity estimates from the sequence of range estimates, including linear regression, Kalman filtering, or the Hough transform. However, some embodiments realized through experimentation that there are two main problems with the existing solutions: 1) During the process of making a sequence of range estimates, a target may have motion in both longitudinal and transverse directions. Looking at the change in distance only accounts for longitudinal motion. So tracking is needed in the transverse direction to make sure the range estimates correspond to the same object. 2) During each estimation time, the target is moving, which can degrade the quality of the range estimate. It is a realization of various embodiments that the problems stem from the assumption that there is no motion during a range estimate (i.e., the scene is quasi-static during each component measurement), which has an obvious mismatch when trying to track moving objects.

Various embodiments are therefore directed towards estimation of instantaneous velocity of a target object directly from the photon detections pertaining to the reflected illumination from the target object. In this regard, some embodiments recognize that the periodic illumination of SPL can be considered to be a form of AMCW, where the amplitude modulation is a pulse train rather than a sinusoid. Thus, the velocity of an illuminated target likewise causes a Doppler shift, which can be observed as a change in the pulse repetition frequency. The Doppler effect describes how the observed frequency of wave phenomena changes as a function of the relative velocity between the wave source and observer.

Doppler lidar is conventionally based on coherent (i.e., homodyne or heterodyne) detection, where the Doppler effect is observed as a shift in the optical frequency of the light reflected from a moving target. Continuous wave (CW) Doppler lidar uses a CW laser and heterodyne detection to measure the Doppler shift from the beat frequency, and is commonly used for velocity measurements of air or other gases. Range can also be measured with additional modulation of the laser's amplitude, frequency, or phase. For instance, frequency-modulated CW lidar (FMCW) lidar, which applies triangular frequency modulation to a CW laser, enables both range and Doppler velocity to be estimated from the sum and difference of a pair constant beat frequencies. As a result, joint range and velocity sensing-sometimes branded as “4D lidar”—is often touted as an advantage of coherent lidar. However, FMCW has other disadvantages compared to time-of-flight systems, particularly that the illumination systems are much more complex, and the temporal coherence of the laser limits the maximum range.

With amplitude modulated continuous-wave (AMCW) lidars, there is a key observation that a Doppler shift occurs in the amplitude modulation frequency, which can be measured with an incoherent detector. Driven by this insight, some embodiments realize that in an SPL system, if the photon detection times are measured relative to the start of the photon emission time instead of the most recent illumination pulse, the photon detections in the observed pulse train are periodic. In fact, the periodic pulsing of SPL makes it a form of AMCW lidar where Doppler shift can be observed in the pulse repetition frequency. Various embodiments take advantage of the fact that velocity is encoded in the absolute detection times, which are measured with respect to the start of an SPL acquisition and retain the order of detection. As such, by modelling the direct photon detection in Doppler SPL, various embodiments inherently accounts for shot noise, and the pulsed illumination enables precise measurement even at low speeds.

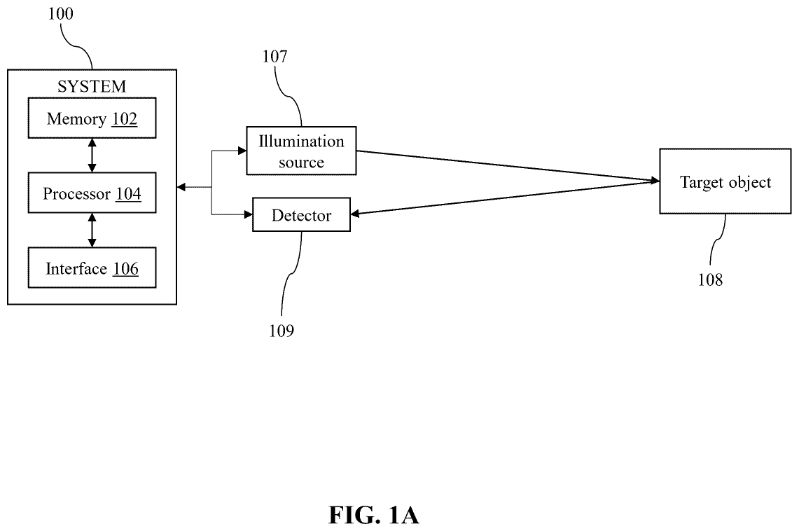

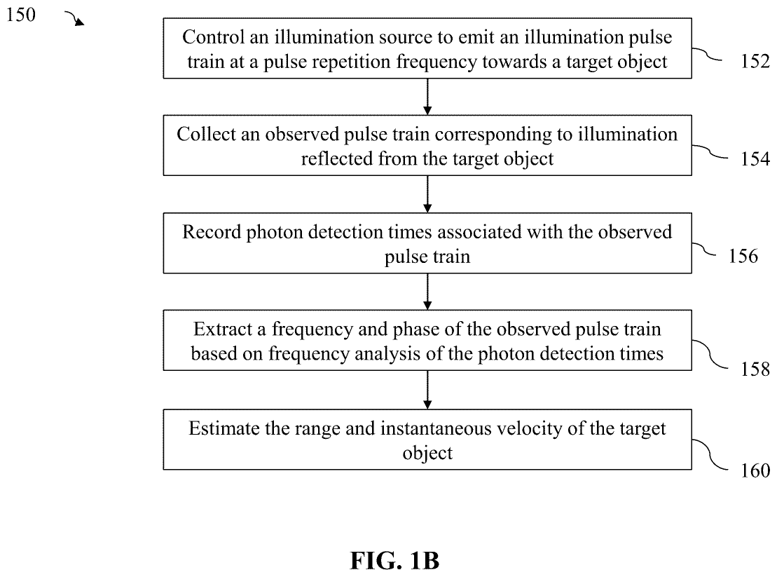

FIG. 1A illustrates a schematic of a system 100 for joint estimation of range and velocity of a target object 108, according to some example embodiments. The system 100 comprises a memory storing different types of data, instructions, and software modules that are utilized by a processor 104 of the system 100 to estimate the range and velocity of the target object 108. The system 100 may also comprise an interface configured to perform data exchange with other components of the system 100 or with other systems.

It may be contemplated that tracking of an object such as the target 108 may amount to continuous range estimation of the target 108. In this regard, either or both of the system 100 and the target 108 may be under motion. In some embodiments, one of the target 108 or the system 100 may be under motion and the tracking of the target 108 may correspond to periodic estimation of the range to the target 108. According to some embodiments, the system 100 may obtain a map of a space in which the target 108 is located and determine the coordinates of the target 108 based on the estimated range. The system 100 may additionally or optionally also determine the instantaneous velocity of the target relative to the system 100 or the detector 109. Thus, the system 100 may be utilized in a variety of applications where range and velocity estimation is a fundamental or primary requirement.

The operations performed by the system 100 are described next with reference to FIG. 1B which illustrates a method 150 for joint estimation of range and velocity of the target object 108. The system 100 controls 152 an illumination source such as the illumination source 107 of FIG. 1A to emit an illumination pulse train at a pulse repetition frequency such that the illumination pulse train illuminates the scene containing the target object 108. In this regard, the illumination source 107 may periodically emit illumination pulses for illuminating the scene containing the target object 108. The illumination source 107 comprises an illuminator such as a laser or light emitting diode (LED). The illumination source 107 may provide any suitable illumination of choice and can be configured accordingly. For example, the illumination source 107 may be a laser source emitting periodic laser pulses. The illumination source 107 has a pulse repetition rate at which pulses of illumination are emitted from it.

The emited illumination pulses travel to the target object 108 and are reflected from it back to the system 100 where a detector 109 detects the reflected illumination. Towards this end, the detector 109 may be realized with one or more sensors and associated optics and electronics. For example, the detector 109 may comprise focusing optics to collect the reflected ilumination from the target 108 onto one or more photodiodes. According to some embodiments, the objective for range and velocity estimation may not include signal processing for the received reflections, and accordingly the detector 109 may only count the time of arrival of the reflected signal towards the detection of the reflected signal. According to some embodiments, the detector 109 may have a focused field of view to filter out noise or scattered illuminations reaching the detector 109. Still, in some embodiments, the detector 109 may apply one or more filters to the detected signal to remove outliers or noise. Since the emitted pulses are in sequence, the detector 109 also performs a sequence of detections of the reflected illuminations. In effect, the detector 109 collects 154 an observed pulse train corresponding to the illuminations reflected from the scene.

In some embodiments, the illumination source 107 may be a picosecond-pulsed laser and the detector 109 may be a single-photon avalanche diode (SPAD) detector. A time-correlated single-photon counting (TCSPC) module may be used by the processor 104 to timestamp the photon detections along with laser pulse times. Thus, the processor 104 records 156 photon detection times associated with the observed/detected/received pulse train.

The processor 104 may be communicatively coupled with the illumination source 107 and the detector 109. The detected reflections are obtained by the processor 104 through the interface 106 and processed to estimate the range and instantaneous velocity of the target object. In this regard, the processor may perform frequency analysis on the recorded photon detection times to extract 158 a frequency and phase of the observed pulse train. The processor then estimates 160 the range and instantaneous velocity of the target object 108 based on the extracted frequency and phase of the observed pulse train.

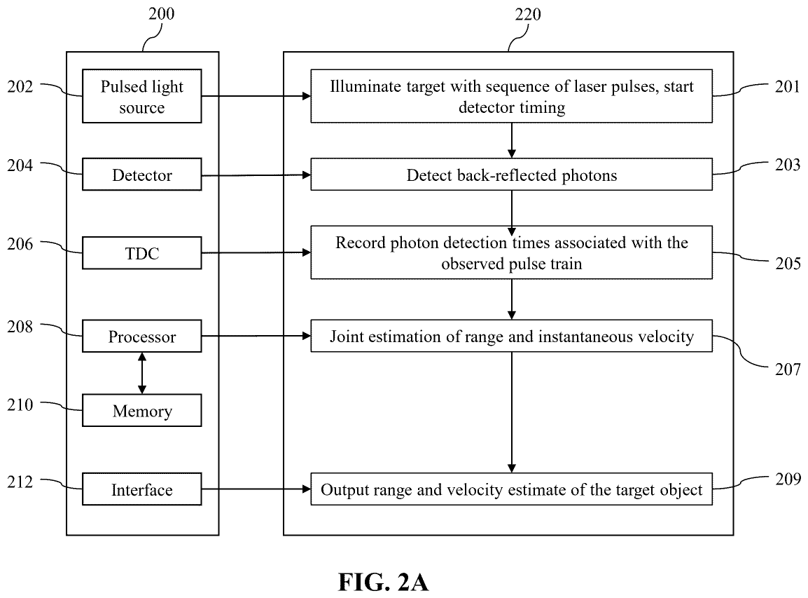

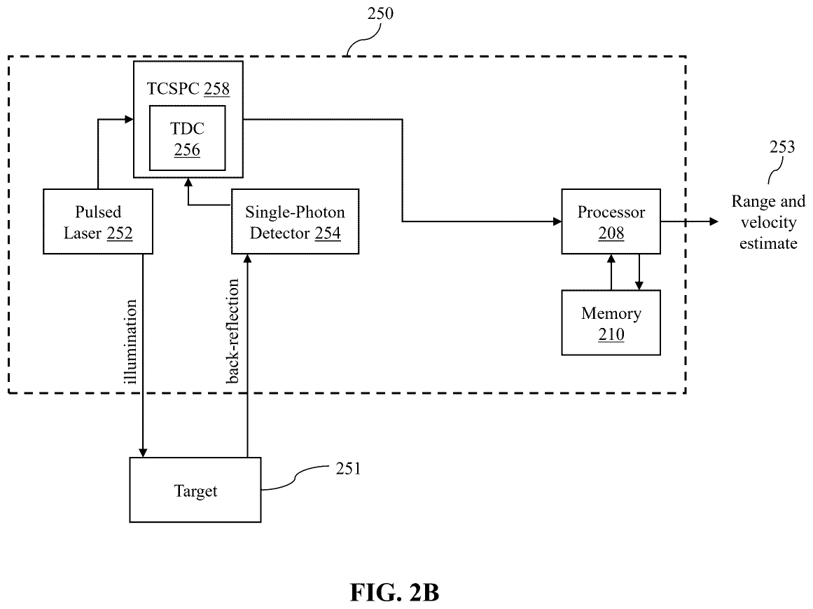

FIG. 2A shows a framework for measurement of range and instantaneous velocity of a moving target using a single photon lidar (SPL) system, according to some example embodiments. The framework depicts the process 220 of jointly estimating a target's range and velocity relative to a detector based on photon detection times recorded by the SPL system 200. A pulsed light source 202 illuminates 201 the target with a sequence of laser pulses. At this instance, a time-correlated single-photon counting (TCSPC) module is triggered to start so as to measure the detection time of each detected photon. When a back-reflected photon 203 impinges on the detector 204 (i.e., is detected by the detector), it produces a spike in electrical current at the corresponding detection time. The detector 204 converts this current spike to a voltage spike, which triggers the TCSPC module to stop. The time-to-digital convertor (TDC) 206 in the TCSPC module converts the time delay between the start and stop triggers into a digitzed measurement of the photon detection time. The processor 208 records 205 photon detection times associated with the observed pulse train and stores the recorded photon detection times in memory 210 for each acquisition period.

For each acquisition period, the processor 208 jointly estimates 207 the range and velocity of the target by Fourier analysis of the photon detection times during that acquisition period. The estimated range and velocity is output 209 by an interface 212. For multiple acqusition periods in sequence, the estimated range and velocity may be displayed as a trajectory on a display interface.

FIG. 2B shows a schematic of a pulsed SPL system 250 for range estimation and velocimetry, according to some example embodiments. A pulsed laser 252 produces periodic pulses of laser illuminations to illuminate the target 251. The single-photon detector (SPD) 254 may comprise one or more of a single-photon avalanche diode (SPAD), superconducting nanowire photodetector (SNSPD), photomultiplier tube (PMT), or other SPD. Instead of measuring the time-resolved light intensity directly, the pulsed SPL system 250 may record the time stamps of individual photon detections with a time-to-digital converter (TDC) 256. The TDC may be realized through suitable circuitry that generates a digital output corresponding to each photon detection timestamp. The TDC 256 along with the SPD 254 thus generates raw data as a sequence of photon detection time stamps. In some embodiments, a time-correlated single-photon counting (TCSPC) module 258 timestamps the photon detections along with laser pulse times (emission time of each laser pulse). The processor 208 executes the instructions stored in memory 210 to jointly perform range estimation and velocimentry using the photon detection times during an acquisition period to produce the range and velocity estimate 253 for the target 251.

The advantages of SPL are two-fold. First, the sensitivity to single photons means even weaker light can be detected, either from lower-power laser sources or weaker (e.g., more distant or darker) target reflections. Second, the time stamps for individual photons can be recorded at as low as picosecond scales, allowing for shorter pulse durations and thus achieving greater precision than can typically be achieved with classical ToF lidar.

A conventional photon detection model for SPL assumes the target to be static. Consider an illumination source to emit nᵣ short periodic pulses with repetition period tᵣ. The temporal pulse shape h(t) is normalized such that

$${\int }_{- ∞}^{∞} h ( t ) dt = 1 .$$

Let tₐ:=nᵣtᵣ denote the acquisition time. If the target is at a distance z₀ away, the time of flight for each laser pulse is τ₀=2z₀/c, where c is the speed of light. Then photon detection follows an inhomogeneous Poisson process with a periodic intensity:

$$μ ( t ) = S [ {\sum }_{n = 0}^{{n}_{r} - 1} h ( t - {τ}_{0} - n {t}_{r} ) ] + b , t ∈ [ 0 , {t}_{a} ) , \qquad ( 1 )$$

where S denotes the signal flux, i.e., the mean number of detected signal photons per period, and b denotes the background intensity which absorbs effects of ambient light and detector's dark counts.

Analogous to the signal flux S, some embodiments consider the background flux B:=btᵣ as the mean number of background detections per period. The signal flux S absorbs effects of the laser's power, target's reflectivity, radial fall-off, and detector's efficiency. The signal-to-background ratio (SBR) is then given as S/B.

Some embodiments consider a case where the target is initially at distance z₀ and moving with a constant velocity ν, where a positive value of ν indicates the target moving away from the detector. As discussed previously, since pulsed illumination can be considered a form of amplitude modulation, a moving target will likewise cause a Doppler shift in the observed pulse repetition frequency. However, photon detection still follows an inhomogeneous Poisson process, but the intensity function changes in accordance with the Doppler shift:

$$λ ( t ) = S [ {\sum }_{n = 0}^{{n}_{r} - 1} h ( t - \frac{c}{c - v} {τ}_{0} - n \frac{c + v}{c - v} {t}_{r} ) ] + b , t ∈ [ 0 , {t}_{a} ) , \qquad ( 2 )$$

The term ((c+ν)/(c−ν))tᵣ may be defined to be the receiving repetition period

$${t}_{r}^{′}$$

and the term (c/(c−ν))τ₀ may be defined to be the Doppler-shifted time-of-flight τ.

If there are N photon detections during the acquisition interval [0, tₐ), then Doppler SPL records the absolute detection times winch are

$$T := {( {T}_{i} )}_{i = 1}^{N}$$

which are relative to t=0.

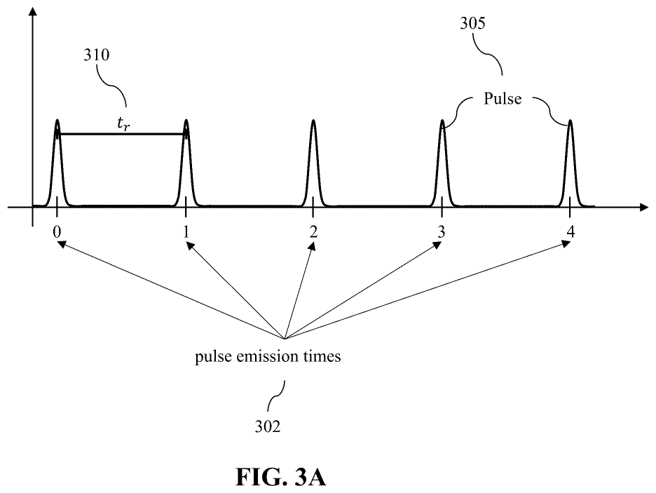

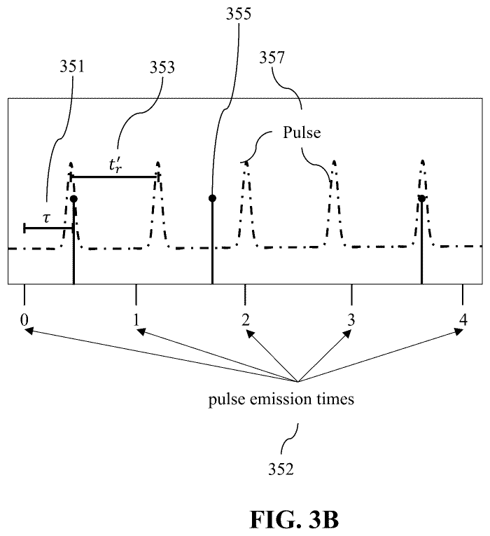

FIG. 3A illustrates a timing diagram showing an illumination pulse train produced by a pulsed single photon lidar system, according to some example embodiments. The illumination intensity of each pulse 305 is periodic with an inter pulse period tᵣ 310. The inter pulse period tᵣ 310 is the time gap between the pulse emission times 302 of two consecutive pulses in an illumination pulse train. The inter pulse period tᵣ 310 may also be referred to as the pulse repetition period and the frequency counterpart of the same may be referred to as the pulse repetition frequency.

FIG. 3B illustrates a timing diagram showing an observed pulse train detected by a pulsed single photon lidar system, according to some example embodiments. The detection intensity of the detected/observed pulses 357 shown in dashed lines is a scaled and shifted version of the illumination intensity due to time-of-flight, Doppler shift, ambient background light, and dark counts. Photon detections 355 may occur after the Doppler-shifted time-of-flight τ 351 of the emitted pulses which are emitted at periodic pulse emission times 352. The observed pulse train may comprise a plurality of observed pulses 357 that are detected periodically at a receiving repetition period

$${t}_{r}^{′} .$$

Doppler SPL such as the one illustrated in FIG. 2B enables velocimetry by quantifying the difference between the transmitting frequency fᵣ:=1/tᵣ and the Doppler-shifted receiving frequency

$${f}_{r}^{′} := 1 / {t}_{r}^{′} .$$

Since the modulation is a pulse train and not a sinusoid, the Doppler shift occurs not only for the fundamental repetition frequency but also the higher harmonics.

The intensity spectrum may be defined as the Fourier transform of the detection intensity given in eqn. (2) as:

$$\tilde{λ} ( f ) = {Sf}_{r}^{′} {t}_{a} {\sum }_{k = - ∞}^{∞} \{ {e}^{- j2π [ {kf}_{r}^{′} τ + \frac{{t}_{a}}{2} ( f - {kf}_{r}^{′} ) ]} \tilde{h} ( {kf}_{r}^{′} ) sin c [ {t}_{a} ( f - {kf}_{r}^{′} ) ] \} + {bt}_{a} {e}^{- j π {ft}_{a}} sin c ( {t}_{a} f ) , \qquad ( 3 )$$

where \tilde{h}(f) is the Fourier transform of the pulse shape h(t). The magnitude of the intensity spectrum |\tilde{λ}(f)| has local maxima at harmonic frequencies

$${\{ {kf}_{r}^{′} \}}_{k ∈ ℤ} .$$

The detection intensity given in eqn. (2) is implicitly multiplied by an indicator function 1_{[0, t}_{ₐ}₎, which becomes the terms

$${\{ sin c [ {t}_{a} ( f - {kf}_{r}^{′} ) ] \}}_{k ∈ ℤ}$$

in the Fourier domain. The longer the acquisition time tₐ, the narrower the frequency bands at the harmonics of

$${f}_{r}^{′}$$

and thus the more robust the velocity estimation in the frequency domain.

Towards identifying the Doppler shift, some embodiments first estimate the spectrum from the photon detection times. The intensity spectrum may be estimated from the detection times T with the probed spectrum as:

$${φ}_{T} ( f ) := {\sum }_{T ∈ T} exp ( - j 2 π fT ) \qquad ( 4 )$$

The magnitude of the probed spectrum |φ_{T}(f)| tracks that of the intensity spectrum intensity spectrum |\tilde{λ}(f)|.

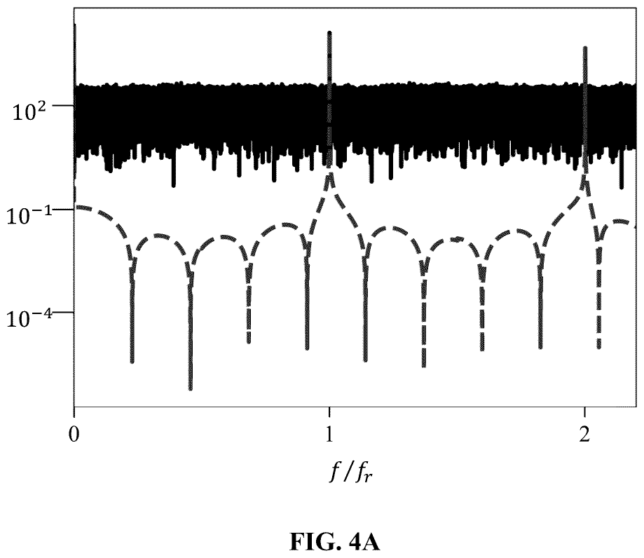

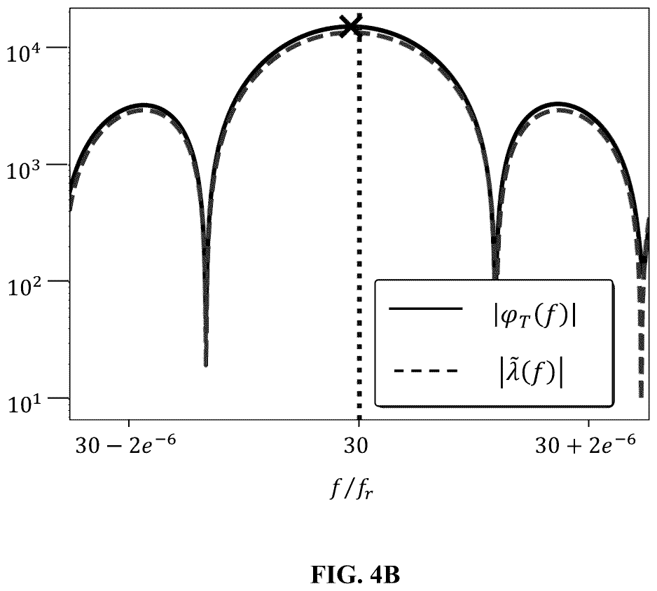

FIG. 4A illustrates magnitudes of exemplary probed spectra and intensity spectra at first two harmonics of the transmission frequency of the illumination pulse train of FIG. 3A, according to some embodiments. In the example considered, the transmitting frequency fᵣ is 40 MHz and the target's velocity is 0.35 m/s, resulting in −0.094 Hz Doppler shift. Although the Doppler shift is small, deviations of local maximal points from harmonics of the transmitting frequency fᵣ become larger at higher harmonics, as, for example, shown in FIG. 4B which illustrates magnitudes of exemplary probed spectra and intensity spectra at 30^{th} harmonic of the transmission frequency of the illumination pulse train of FIG. 3A, according to some embodiments.

### Fourier Velocity Estimator

Some embodiments estimate the receiving frequency by probing around the harmonics of the transmitting frequencies:

$$\text{?} = arg {max}_{f ∈ [ {f}_{m i n} , {f}_{m ax} ]} {\sum }_{k ∈ K} {\vert {φ}_{T} ( kf ) \vert}^{2} \qquad ( 5 )$$

where fₘᵢₙ and fₘₐₓ bounds the optimization domain for the local maxima, and K is a set of integers. The velocity estimate corresponding to the estimated received frequency

$${f}_{r}^{′}$$

is:

$$\hat{v} = c ( {f}_{r} - \text{?} ) / ( {f}_{r} + \text{?} ) \qquad ( 6 )$$

The search region defined by [fₘᵢₙ, fₘₐₓ] may be selected according to a prior knowledge of the target's maximum speed νₘₐₓ. Since the received frequency

$${f}_{r}^{′} = \frac{( c - v )}{( c + v )} {f}_{r} ,$$

$${f}_{m i n} = \frac{( c - {v}_{m ax} )}{( c + {v}_{m ax} )} {f}_{r} , {f}_{m ax} = \frac{( c + {v}_{m ax} )}{( c - {v}_{m ax} )} {f}_{r} \qquad ( 7 )$$

Some embodiments are based on the realization that probing the spectrum at multiple harmonics makes the estimator more robust to background photon detections. In this regard, the set of harmonics K={1, 2, . . . , kₘₐₓ} may be chosen to be as large as possible given the Nyquist rate and computation constraints.

First, to avoid aliasing in the probed spectrum, the maximum probe frequency kₘₐₓfₘₐₓ must not exceed the Nyquist rate f_{Nyquist}=1/(2tᵣₑₛ), where tᵣₑₛ is the effective timing resolution of the SPL system. The effective timing resolution depends on the quantization of the timing electronics, time jitter, and the laser temporal pulse width. According to some embodiments, the effective timing resolution may be chosen as tᵣₑₛ=4σ, where σ is the laser pulsewidth.

Second, the number of harmonics |K| increases the computation time, depending on the optimization routine used to compute Eq. (5). Accordingly, kₘₐₓ may be chosen to be smaller than the value dicated by the Nyquist rate to limit computation time.

### Fourier Distance Estimator

While the magnitude of the probed spectrum reveals the target's velocity, the distance is encoded in the phase. Assuming that b=0, and h(t) is real and even, the phase of the intensity spectrum \tilde{λ}(f) at

$$f = {f}_{r}^{′}$$

is given as:

$$arg [ \tilde{λ} ( {f}_{r}^{′} ) ] \approx ( - 2 π {f}_{r}^{′} τ ) mod 2 π \qquad ( 8 )$$

Therefore, the Doppler-shifted time-of-flight may be estimated by probing at the estimated receiving repetition frequency [symbol] :

$$\hat{τ} = \{ - \text{?} arg [ {φ}_{T} ( \text{?} ) ] / ( 2 π ) \} mod \text{?} , \qquad ( 9 )$$

where

$$\text{?} = 1 / \text{?} .$$

The corresponding estimate of the initial time-of-flight is \hat{τ}₀=(c−ν)τ/c, which corresponds to the initial distance estimate \hat{z}₀=c \hat{τ}₀/2. The ambient light intensity b changes the phase

$$arg [ \tilde{λ} ( {f}_{r}^{′} ) ] .$$

### Maximum Likelihood Distance and Velocity Estimator

Some embodiments are also based on the realization that the range and velocity estimated by the Fourier analysis can be further improved via joint maximum likelihood estimation. Specifically, the Fourier estimator described above first nonparametrically estimates the spectrum via the periodogram and then performs parameter estimation for ν and z₀. However, the periodogram may be an efficient estimator for certain classes of Poisson process intensities. In this regard, it is a realization of some embodiments that maximum likelihood estimation tends to yield better results if the process intensity has a known parametric form. Since for most practical applications the assumption ν<<c holds true, the likelihood given the intensity function Eq. (2) can be approximated as

$$ℒ ( S , B , {τ}_{0} , v ) \approx - {n}_{r} ( S + B ) + {\sum }_{T ∈ T} log ( Sh ( T mod {t}_{r} - \frac{2 v T}{c} - {τ}_{0} ) + \frac{B}{{t}_{r}} ) \qquad ( 10 )$$

This approximation offers a simple interpretation: the target moves by νT at time T, resulting in a change in the time-of-flight by 2νT/c. The maximum likelihood estimator is

$$\hat{S} , \hat{B} , {\hat{τ}}_{0} , \hat{v} = {arg max}_{S , B , {τ}_{0} , v} ℒ ( S , B , {τ}_{0} , v ) . \qquad ( 11 )$$

If any of the parameters S, B, τ₀, ν are known or estimated a priori, they can be fixed in the log likelihood. Otherwise, all parameters can be jointly estimated.

Some embodiments also realize that the optimization problem in Eq. (11) is hard, because the objective is nonconcave in τ₀ and ν. Accordingly, some embodiments implement Eq. (11) by initializing the four parameters with a preliminary estimator such as the ones discussed previously and then apply a first-order optimization routine to refine the solution. For example, ν may be initialized using the Fourier velocity estimator described previously with reference to Eq. (6). Then given the estimate \hat{ν}, hypothetical relative detection times may be computed assuming there is no movement as X=T mod tᵣ−2\hat{ν}T/c. Some estimation methods for static targets may then be applied to obtain a preliminary estimate of the other three parameters from

$$\tilde{χ} = {( {\tilde{X}}_{i} )}_{i = 1}^{N} .$$

Given the signal flux estimate Ŝ and the background flux estimate \hat{B}, the ML distance estimator may be applied for the initial time-of-flight:

$${\hat{τ}}_{0} = {arg max}_{{τ}_{o}} {\sum }_{\tilde{X} ∈ \tilde{χ}} log ( \hat{S} h ( \tilde{X} - {τ}_{0} ) + \hat{B} / {t}_{r} ) . \qquad ( 12 )$$

With the initialization of S, B, τ₀, ν, Eq. 11 may be computed by using the the Limited-memory Broyden-Fletcher-Goldfarb-Shanno—bound constraints (L-BFGS-B) algorithm.

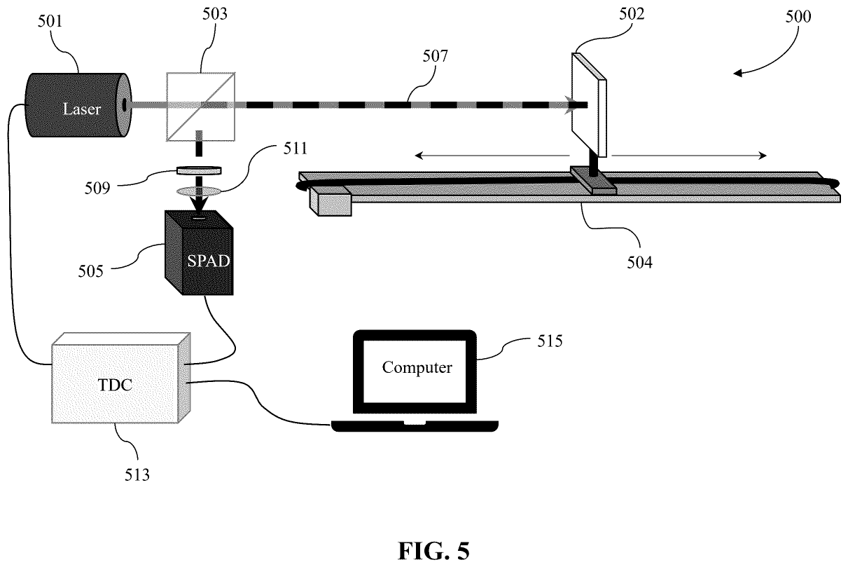

FIG. 5 shows a detailed schematic of a single-photon lidar system 500 for estimating range and velocity of a moving target, according to some example embodiments. According to some embodiments, the SPL may also be referred to as a Geiger-mode Lidar that detects photon counts one at a time. A pulsed laser 501 illuminates a target object 502 that is movable in at least one dimension such as on a setup bench 504. A SPAD detector 505 observes the same optical axis 507 as the pulsed laser 501 through a beam-splitter 503. The light reaching the SPAD detector 505 is focused by a lens 509 and spectrally filtered by a filter 511 to only allow light at the laser wavelength to reach the detector 505. The measurement for a sequence of pulses is a sequence of photon detection times recorded with a time-to-digital converter (TDC) 513. The TDC 513 thus provides raw data as a sequence of photon detection time stamps to a computer 515.

In general, the photons detected by the SPAD detector 505 are random observations of the full waveform signal, consisting of the back-reflected pulse, noise, and other degradations such as interference or multi-path. Due to the statistical nature of single photon detection, not every pulse will necessarily be followed by a photon detection. Alternatively, depending on the single-photon detector configuration, some pulses may be followed by multiple photon detections. Accumulating photon detections over time by the computer 515 leads to a temporal histogram that approximates a full-waveform measurement. In lidar acquisitions for static targets, depth estimators can use the entire sequence of photon detection time stamps. However, for moving targets, separate depth estimates are desired for smaller units of time, in order to properly track the target motion. Thus, the acquisition time during which all photon detection time stamps are acquired can be sub-divided into a sequence of sub-acquisitions corresponding to a fraction of all emitted laser pulses. Each sub-acquisition in turn comprises multiple photon detection times.

Corresponding to each such sub-acquisition, the computer 515 may perform the Fourier analysis of the detection times which yields an initial estimate of the range and velocity of the target 502. By implementing the maximum likelihood estimator discussed previously, the computer 515 obtains a robust estimation of the range of the target 502 with respect to the detector 505 and the relative instantaneous velocity of the target 502 with respect to the detector 505.

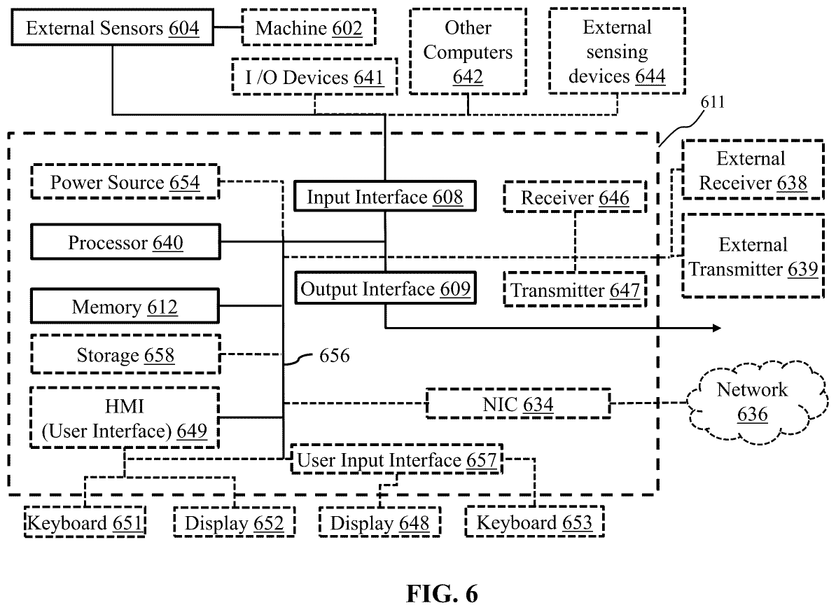

FIG. 6 illustrates a block diagram of some components of a controller computer 611 for controlling a lidar system for joint estimation of range and velocity of an object, according to some example embodiments. The controller computer 611 includes a processor 640, a computer readable memory 612, storage 658 and user interface 649 with optional display 652 and keyboard 651, which are connected through bus 656. For example, the user interface 664 in communication with the processor 640 and the computer readable memory 612, acquires and stores the photon detection data in the computer readable memory 612 upon receiving a control input or an input from a surface, keyboard 653, of the user interface 657 by a user.

The controller computer 611 can include a power source 654, depending upon the application the power source 654 may be optionally located outside of the controller computer 611. Linked through bus 656 can be a user input interface 657 adapted to connect to a display device 648, wherein the display device 648 can include a computer monitor, television, projector, or mobile device, among others. A network interface controller (NIC) 634 is adapted to connect through the bus 656 to a network 636, wherein output data or other data, among other things, can be rendered to an external device such as a third-party display device, third party imaging device, and/or third-party printing device outside of the controller computer 611.

Still referring to FIG. 6, the output data or other electronic data, among other things, may be transmitted over a communication channel of the network 636, and/or stored within the storage system 658 for storage and/or further processing. Further, time series data or other data may be received wirelessly or hard wired from a receiver 646 (or external receiver 638) or transmitted via a transmitter 647 (or external transmitter 639) wirelessly or hard wired, the receiver 646 and transmitter 647 are both connected through the bus 656. The controller computer 611 may be connected via an input interface 608 to external sensing devices 644 and external input/output devices 641. For example, the external sensing devices 604 may include sensors gathering data. The controller computer 611 may be connected to other external computers 642. An output interface 609 may be used to output the processed data from the processor 640. It is noted that a user interface 649 in communication with the processor 640 and the non-transitory computer readable storage medium 612, acquires and stores the various types of data in the non-transitory computer readable storage medium 612 upon receiving an input from a surface of the user interface 649 by a user.

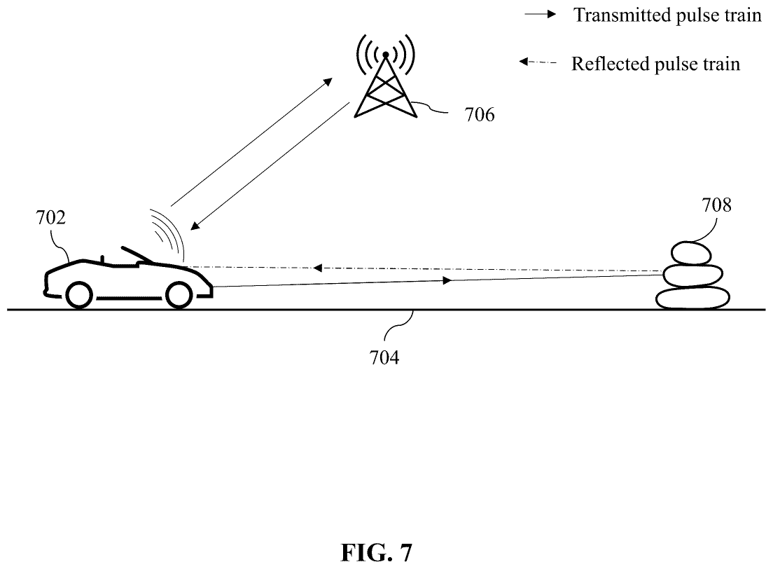

FIG. 7 illustrates a scenario depicting an example use case of an SPL system such as the system 500 of FIG. 5 for joint estimation of range and velocity of objects in a scene, according to some example embodiments. A vehicle 702 moving on a road link 704 may be connected to a base station 706. The road link may have one or more obstacles 708 and the goal may be to traverse the road link 704 without colliding with the obstacles 708. Towards this end, it is required that a correct estimation of the depth/range of the obstacles 708 be determined so that a route for the vehicle 702 may be planned so as to avoid the obstacles 708. In this regard, the relative velocity of the obstacle 708 with respect to the vehicle 702 may also be helpful in determining the maneuvers for the vehicle.

The vehicle 702 may be a manually driven vehicle, a semi-autonomous vehicle or a fully autonomous self-driving vehicle and may be configured for communication with the base station 706. In this regard, the vehicle 702 may be equipped with suitable components to execute remote sensing, data communication, and data processing. Towards this end, it may be contemplated that the vehicle may be equipped with an onboard single point (low photon count) lidar system such as the ones described earlier in this disclosure. An emitter of the lidar system transmits a pulse of radiation (shown as solid line) towards the obstacles 708 and receives a reflection (shown as dotted line) of the transmitted pulse from the scene ahead. Since the vehicle 702 may be moving, the depth estimation of the obstacles 708 may not be correctly inferable using conventional techniques.

A controller of the vehicle 702 may invoke the system to perform position tracking and velocity estimation jointly for the obstacles 708. The system may be fully or partially onboard the vehicle 702. In embodiments where the system is partially onboard the vehicle 702, the computation steps leading to range and velocity estimation may be performed via edge computing on the base station 706. In some example embodiments, the vehicle 702 may determine through the SPL system, the correct range and relative velocity of the obstacles 708 in accordance with the example embodiments described previously in the disclosure and thereby determine a geo-location of the obstacles 708, for example using map data. Accordingly, the onboard controller of the vehicle 708 may determine maneuvers to reroute the vehicle 708 to avoid collision with the obstacles 708 considering the estimated range and the velocity. In some example embodiments, the vehicle 702 may additionally or alternately convey at least the geo-location of the obstacles 708 to the base station 706 for updating a map of the area in which the road link 704 exists.

Although the example use case is described with reference to an on-road vehicle, example embodiments described herein may be applicable to any type of vehicle such as a railway wagon, or a spacecraft moving in one dimension, and the like. Other example uses of some embodiments include industrial robotics, computer vision systems and camera autofocus to name a few.

The joint estimation of range and velocity using SPL as illustrated in various embodiments of the disclosure is robust to a wide range of SBR levels and velocities. Despite the non-convex nature of the ML estimation problem, the proposed Fourier-based estimator of the Doppler shift provides a good enough initialization to achieve statistically optimal results. The introduction of velocimetry for SPL opens the door to many of the same questions that have previously been addressed for distance and reflectivity imaging, such as how to achieve good accuracy at long range with few photons, underwater, or through obscurants etc.

The above description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements. Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A system for joint estimation of range and instantaneous velocity of a target object in a scene, comprising:
circuitry configured to:
control an illumination source to emit an illumination pulse train at a pulse repetition frequency for illuminating the scene;
collect an observed pulse train corresponding to illumination reflected from the scene;
record photon detection times associated with the observed pulse train;
perform frequency analysis on the recorded photon detection times to extract a frequency and phase of the observed pulse train; and
estimate the range and instantaneous velocity of the target object, based on the extracted frequency and phase of the observed pulse train.

2. The system of claim 1, wherein the target object is a moving object whose motion causes a Doppler shift in a repetition frequency of the observed pulse train, wherein photon detections corresponding to the observed pulse train follow an inhomogeneous Poisson process, and wherein intensity of the illumination reflected from the scene changes in accordance with the Doppler shift.

3. The system of claim 1, wherein the photon detection times associated with the observed pulse train correspond to absolute detection times of photons detected during an acquisition interval, and wherein each absolute detection time of the absolute detection times is defined relative to a beginning time instance of the acquisition interval.

4. The system of claim 1, wherein to extract the frequency and phase of the observed pulse train, the circuitry is configured to estimate an intensity spectrum of the observed pulse train based on Fourier transformation of a probed spectrum of the photon detection times of the observed pulse train.

5. The system of claim 4, wherein to extract the frequency of the observed pulse train, the circuitry is further configured to:
determine an initial estimate of the frequency of the observed pulse train based on a magnitude of the intensity spectrum and the pulse repetition frequency of the illumination pulse train; and
determine an initial estimate of the velocity of the target object based on the pulse repetition frequency of the illumination pulse train and the initial estimate of the frequency of the observed pulse train.

6. The system of claim 5, wherein to extract the phase of the observed pulse train, the circuitry is further configured to determine an initial estimate of the phase of the intensity spectrum at the initial estimate of the frequency of the observed pulse train.

7. The system of claim 6, wherein the circuitry is further configured to estimate a Doppler-shifted time of flight corresponding to the observed pulse train based on the initial estimate of the phase of the intensity spectrum and the initial estimate of the frequency of the observed pulse train.

8. The system of claim 7, wherein to estimate the range and instantaneous velocity of the target object, the circuitry is configured to solve an optimization problem that determines the values of the range and the velocity of the target object that maximize the likelihood given the photon detection times.

9. The system of claim 1, wherein the illumination source is a single photon lidar.

10. The system of claim 9, wherein the circuitry comprises a single-photon detector to detect the illumination reflected from the scene and generate within a total acquisition time, raw data as a sequence of photon detection time stamps.

11. A computer-implemented method for joint estimation of range and instantaneous velocity of a target object in a scene, comprising:
controlling an illumination source to emit an illumination pulse train at a pulse repetition frequency for illuminating the scene;
collecting an observed pulse train corresponding to illumination reflected from the scene;
recording photon detection times associated with the observed pulse train;
performing frequency analysis on the recorded photon detection times to extract a frequency and phase of the observed pulse train; and
estimating the range and instantaneous velocity of the target object, based on the extracted frequency and phase of the observed pulse train.

12. The method of claim 11, wherein the target object is a moving object whose motion causes a Doppler shift in a repetition frequency of the observed pulse train, wherein photon detections corresponding to the observed pulse train follow an inhomogeneous Poisson process, and wherein intensity of the illumination reflected from the scene changes in accordance with the Doppler shift.

13. The method of claim 11, wherein the photon detection times associated with the observed pulse train correspond to absolute detection times of photons detected during an acquisition interval, and wherein each absolute detection time of the absolute detection times is defined relative to a beginning time instance of the acquisition interval.

14. The method of claim 11, wherein the extracting the frequency and phase of the observed pulse train comprises estimating an intensity spectrum of the observed pulse train based on Fourier transformation of a probed spectrum of the photon detection times of the observed pulse train.

15. The method of claim 14, wherein the extracting the frequency of the observed pulse train comprises:
determining an initial estimate of the frequency of the observed pulse train based on a magnitude of the intensity spectrum and the pulse repetition frequency of the illumination pulse train; and
determining an initial estimate of the velocity of the target object based on the pulse repetition frequency of the illumination pulse train and the initial estimate of the frequency of the observed pulse train.

16. The method of claim 15, wherein the extracting the phase of the observed pulse train further comprises determining an initial estimate of the phase of the intensity spectrum at the initial estimate of the frequency of the observed pulse train.

17. The method of claim 16, further comprising estimating a Doppler-shifted time of flight corresponding to the observed pulse train based on the initial estimate of the phase of the intensity spectrum and the initial estimate of the frequency of the observed pulse train.

18. The method of claim 17, wherein the estimating the range and instantaneous velocity of the target object comprises solving an optimization problem that determines the values of the range and the velocity of the target object that maximize the likelihood given the photon detection times.

19. The method of claim 11, wherein the illumination source is a single photon lidar.
